(19) United States
(12) Patent Application Publication
(10) Pub. No.: US 2016/0189636 A1
(43) Pub. Date: Jun. 30, 2016

(54) BACKLIGHT CONTROL METHOD AND DEVICE

(71) Applicant: Xiaomi Inc., Beijing (CN)

(72) Inventors: Anyu Liu, Beijing (CN); Guosheng Li, Beijing (CN); Hui Du, Beijing (CN)

(73) Assignee: Xiaomi Inc.

(21) Appl. No.: 14/984,164

(22) Filed: Dec. 30, 2015

(30) Foreign Application Priority Data
Dec. 31, 2014 (CN) 201410856892.5
Jan. 8, 2015 (CN) 201510009475.1

(51) Int. Cl. G09G 3/34; G09G 3/36

(52) U.S. Cl. CPC G09G 3/3406; G09G 3/36; G09G 2320/0646; G09G 2320/0233

(57) ABSTRACT

The present disclosure is directed to a backlight control method and device. The method includes: acquiring, for a display block in a screen, grayscale values of respective pixels in an image displayed in the display block, the screen including one or more display blocks; determining, according to the acquired grayscale values, a minimum value among a predetermined number of largest grayscale values; and when the minimum value reaches or exceeds a threshold grayscale value, controlling the grayscale values of the respective pixels to be unchanged, and controlling a backlight intensity of the display block to be a maximum backlight intensity.

### CROSS-REFERENCE TO RELATED APPLICATIONS

This application is based upon and claims priority to Chinese Patent Application No. 201510009475.1, filed Jan. 8, 2015, and Chinese Patent Application No. 201410856892.5, filed Dec. 31, 2014, the entire contents of all of which are incorporated herein by reference.

### TECHNICAL FIELD

The present disclosure generally relates to display technology and, more particularly, to a backlight control method and device.

### BACKGROUND

Content Adaptive Brightness Control (CABC) is a backlight power-saving technology that may be used in a terminal having a liquid crystal display (LCD).

The CABC technology may adjust, based on an image displayed on a screen, a relationship between grayscale values of the image and backlight intensity of the screen, so as to substantially maintain the display effect of the image while effectively reducing the backlight intensity of the screen. For example, the grayscale values of the image may be increased by 30% to brighten the image, and the backlight intensity of the screen may be reduced by 30% to darken the image. This way, the brightness of the image before and after the above treatment may be kept substantially consistent, but the power consumption by the backlight is reduced by 30%.

### SUMMARY

According to a first aspect of the present disclosure, there is provided a backlight control method, comprising: acquiring, for a display block in a screen, grayscale values of respective pixels in an image displayed in the display block, the screen including one or more display blocks; determining, according to the acquired grayscale values, a minimum value among a predetermined number of largest grayscale values; and when the minimum value reaches or exceeds a threshold grayscale value, controlling the grayscale values of the respective pixels to be unchanged, and controlling a backlight intensity of the display block to be a maximum backlight intensity.

According to a second aspect of the present disclosure, there is provided a backlight controlling device, comprising: a processor; and a memory for storing instructions executable by the processor; wherein the processor is configured to: acquire, for a display block of a screen, grayscale values of respective pixels in an image displayed in the display block, the screen including one or more display blocks; determine, according to the acquired grayscale values, a minimum value among a predetermined number of largest grayscale values; and when the minimum value reaches or exceeds a threshold grayscale value, control the grayscale values of the respective pixels to be unchanged, and control a backlight intensity of the display block to be a maximum backlight intensity.

According to a third aspect of the present disclosure, there is provided a non-transitory computer-readable storage medium storing instructions that, when executed by a processor of a terminal, cause the terminal to perform a backlight control method, the method comprising: acquiring, for a display block in a screen, grayscale values of respective pixels in an image displayed in the display block, the screen including one or more display blocks; determining, according to the acquired grayscale values, a minimum value among a predetermined number of largest grayscale values; when the minimum value reaches or exceeds a threshold grayscale value, controlling the grayscale values of the respective pixels to be unchanged, and controlling a backlight intensity of the display block to be a maximum backlight intensity.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate embodiments consistent with the present disclosure and, together with the description, serve to explain the principles of the present disclosure.

FIG. 1 is a schematic diagram illustrating a terminal using the CABC technology for backlight power-saving control, according to an exemplary embodiment.

FIG. 2 is a flowchart of a backlight control method, according to an exemplary embodiment.

FIG. 3A is a flowchart of a backlight control method, according to an exemplary embodiment.

FIG. 3B is a schematic diagram illustrating a histogram, according to an exemplary embodiment.

FIG. 3C is a schematic diagram illustrating a grayscale value distribution, according to an exemplary embodiment.

FIG. 3D is a schematic diagram illustrating a grayscale value distribution, according to an exemplary embodiment.

FIG. 4 is a block diagram of a backlight control device, according to an exemplary embodiment.

FIG. 5 is a block diagram of a backlight control device, according to an exemplary embodiment.

FIG. 6 is a block diagram of a backlight control device, according to an exemplary embodiment.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the invention. Instead, they are merely examples of apparatuses and methods consistent with aspects related to the invention as recited in the appended claims.

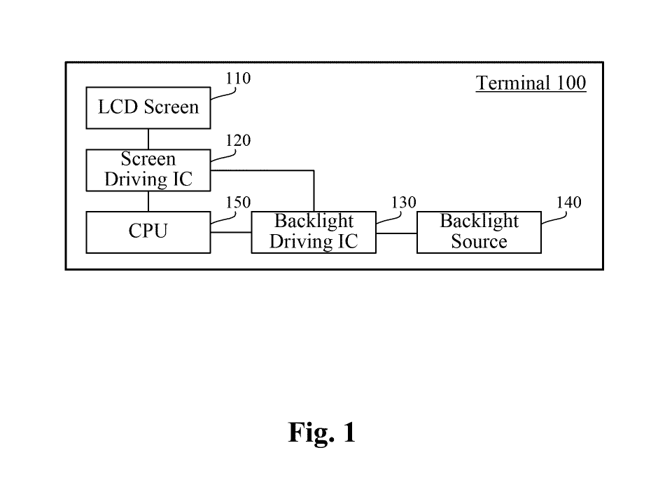

FIG. 1 is a schematic diagram illustrating a terminal 100 that uses the CABC technology for backlight power-saving control, according to an exemplary embodiment. For example, the terminal 100 may be a mobile phone, a tablet, an e-book reader, a Moving Picture Experts Group Audio Layer III (MP3) player, an MP4 player, a portable laptop computer, a desktop computer, and the like. Referring to FIG. 1, the terminal 100 may include a LCD screen 110, a screen driving integrated circuit (IC) 120, a backlight driving IC 130, a backlight source 140, and a central processing unit (CPU) 150.

The CPU 150 is electronically connected to the screen driving IC 120, and configured to transmit images to be displayed to the screen driving IC 120. The screen driving IC 120 is electronically connected to the LCD screen 110, and configured to control the LCD screen 110 to display the images. For example, the LCD screen 110 may be a cold cathode fluorescent lamp (CCFC) screen or a light emitting diode (LED) screen. The backlight driving IC 130 is electronically connected to the CPU 150 and/or the screen driving IC 120. The backlight driving IC 130 is configured to receive pulse width modulation (PWM) signals sent by the CPU 150 and/or the screen driving IC 120, and control backlight intensity of the backlight source 140 according to the received PWM signals.

The backlight control methods illustrated by the following exemplary embodiments of the present disclosure may be implemented by the CPU 150 alone, by the screen driving IC 120 alone, or by the CPU 150 and the screen driving IC 120 jointly. Correspondingly, the backlight control device described in the present disclosure may be entirely integrated in the CPU 150, entirely integrated in the screen driving IC 120, or implemented as different functional modules distributed in the CPU 150 and the screen driving IC 120.

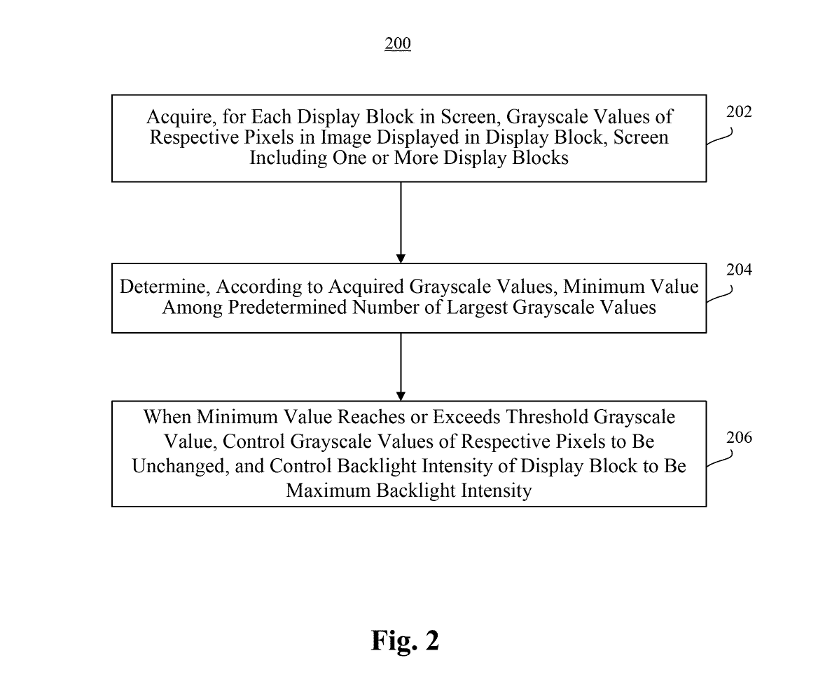

FIG. 2 is a flowchart of a backlight control method 200, according to an exemplary embodiment. For example, the backlight control method may be used in a terminal, such as the terminal 100 (FIG. 1). Referring to FIG. 2, the backlight control method 200 may include the following steps.

In step 202, the terminal acquires grayscale values of respective pixels in an image displayed in a display block of a screen. The screen may include one or more display blocks. The terminal may acquire the grayscale values for each display block in the screen.

In step 204, the terminal determines, according to the acquired grayscale values, a minimum value among a predetermined number of largest grayscale values.

In step 206, when the minimum value reaches or exceeds a threshold grayscale value, the terminal controls the grayscale values of the respective pixels to be unchanged, and controls a backlight intensity of the display block to be a maximum backlight intensity.

Conventionally, when the CABC is used to process an image having pixels with high grayscale values, the image contrast may be significantly decreased and the display effect of the image may be seriously impaired. The method 200 solves the above problem by preventing the CABC from being performed on images having pixels with high grayscale values. Therefore, the method 200 may avoid or reduce the loss of the image contrast, and improve the image quality and the display effect.

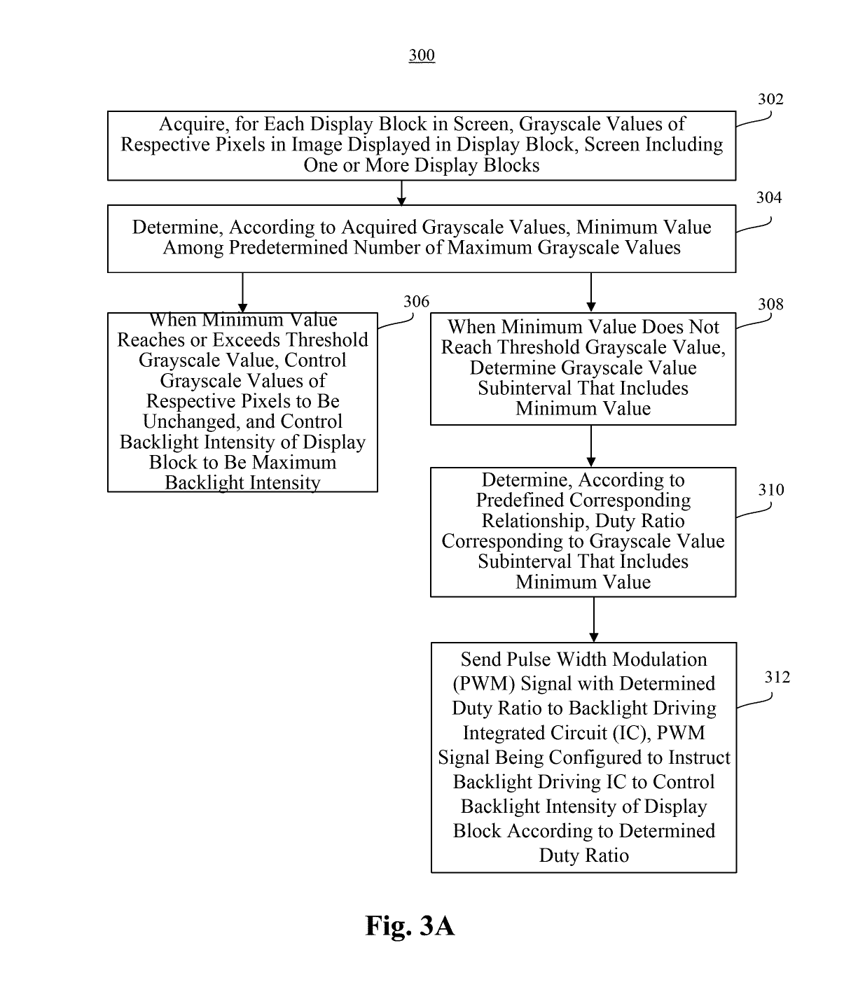

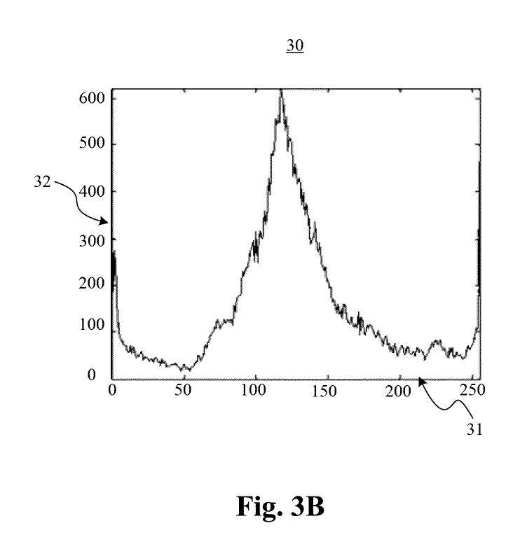

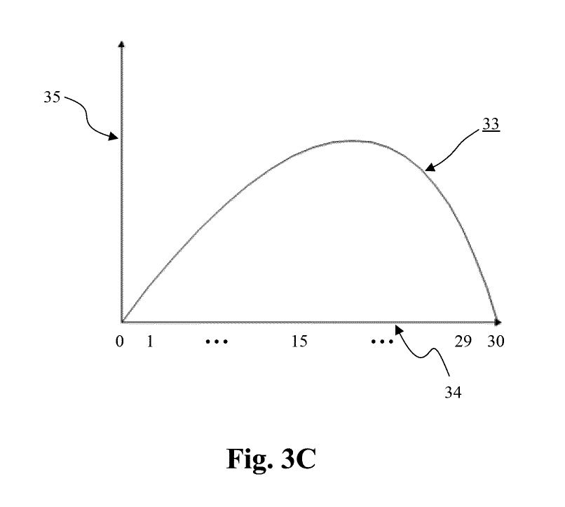

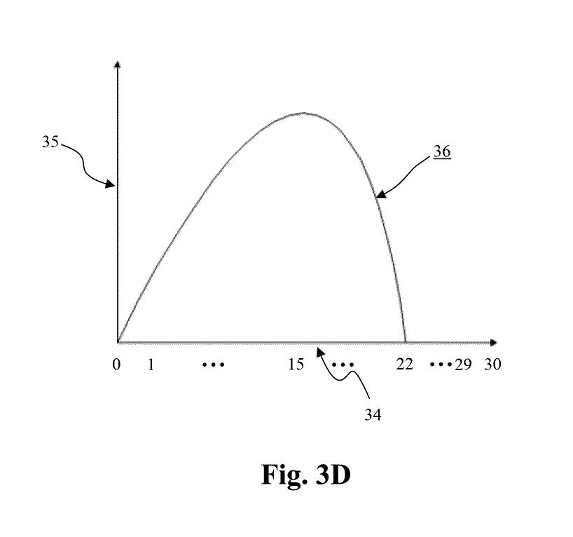

FIG. 3A is a flowchart of a backlight control method 300, according to an exemplary embodiment. For example, the method 300 may be used in a terminal, such as the terminal 100 (FIG. 1). Referring to FIG. 3A, the method 300 may include the following steps.

In step 302, the terminal acquires grayscale values of respective pixels in an image displayed in a display block of a screen. The screen may include one or more display blocks. The terminal may acquire the grayscale values for each display block in the screen.

The screen of the terminal may have one display block, or may have a plurality of display blocks. Each display block corresponds to a group of backlight sources. Each group of backlight sources is used for individually controlling the backlight intensity of the corresponding display block.

When the screen of the terminal has only one display block, the display block is generally used for displaying a complete image. However, the present disclosure does not limit other possible embodiments. For example, the display block may be used for displaying a part of a complete image or a plurality of complete images.

When the screen of the terminal has a plurality of display blocks, generally the plurality of display blocks are used for displaying a complete image, with each display block being used for displaying a part of the complete image. However, the present disclosure does not limit other possible embodiments. For example, the plurality of display blocks may be used for displaying multiple complete images, with each or multiple display blocks being used for displaying a complete image. The backlight intensity of each display block is controlled according to the backlight control method provided by the present disclosure.

The image displayed in a display block may be a picture, a video, or any other types of visual content. For each display block in the screen, the terminal acquires the grayscale values of the respective pixels in an image displayed in the display block. In one implementation of acquiring the grayscale values of the respective pixels in an image, the terminal may perform a histogram statistics on the grayscale values of the pixels in the image, and count the number of the pixels corresponding to each grayscale value. FIG. 3B is a schematic diagram illustrating a histogram 30 of grayscale values, according to an exemplary embodiment. As shown in FIG. 3B, in the histogram 30, the horizontal axis 31 indicates grayscale values, and the vertical axis 32 indicates a number of the pixels.

In step 304, the terminal determines, according to the acquired grayscale values, a minimum value among a predetermined number of largest grayscale values.

The predetermined number may be a preset empirical value. When no contrast loss is permitted during the application of a CABC process on the image, the predetermined number may be set to 1. When contrast loss at a small number of pixels is permitted during the application of the CABC process, the predetermined number may be set to a number greater than 1, such as 5, 10, 15, etc. However, to maintain the image contrast and quality at a desirable level, the predetermined number generally may not be set too large. The larger the predetermined number is, the greater the allowable contrast loss is during the application of the CABC process to the image, which may adversely affect the image quality and display effect.

When the predetermined number is 1, the largest grayscale value is the minimum value. For instance, when the grayscale values acquired in step 302, arranged in an descending order, are 255, 255, 255, 254, 254, 252, 252, . . . , and when the predetermined number is 1, the terminal determines that 255 is the minimum value among the predetermined number of largest grayscale values.

In contrast, when the predetermined number is greater than 1, such as 5, and the grayscale values acquired in step 302, arranged in an descending order, are 255, 255, 255, 254, 254, 252, 252, . . . , the terminal determines that 254 is the minimum value among the predetermined number of largest grayscale values.

In step 306, when the minimum value reaches or exceeds a threshold grayscale value, the terminal controls the grayscale values of the respective pixels to be unchanged, and controls the backlight intensity of the display block to be a maximum backlight intensity.

When the minimum value reaches or exceeds the threshold grayscale value, which indicates that the image may include some pixels with high grayscale values (for example, white pixels), the terminal does not perform the CABC process to the image, so as to preserve the image contrast. The threshold grayscale value may be a preset empirical value whose magnitude relates to the type of the screen. For example, when the screen is an 8 bit panel, the grayscale value interval displayable by the screen is from 0 to 255, and the threshold grayscale value may be set to a number close to the maximum displayable grayscale value 255, such as 250. For another example, when the screen is a 10 bit panel, the grayscale value interval which could be displayable by the screen is from 0 to 1023, and the threshold grayscale value may be set to a number close to the maximum displayable grayscale value 1023, such as 1000.

In some exemplary embodiments, when the minimum value reaches or exceeds the threshold grayscale value, the terminal may send a PWM signal with a 100% duty ratio to a backlight driving IC of the terminal, such as the backlight driving IC 130 (FIG. 1). Such PWM signal may be configured to instruct the backlight driving IC to control the backlight intensity of the display block to be a maximum backlight intensity.

When the minimum value does not reach the threshold grayscale value, the terminal performs the CABC on the image to reduce power consumption by the backlight. In one exemplary implementation, the terminal may continue to perform the following steps 308-312.

In step 308, when the minimum value does not reach the threshold grayscale value, the terminal determines a grayscale value subinterval that includes the minimum value.

The terminal may divide the grayscale value interval [0, Pₘₐₓ] displayable by the screen into M grayscale value subintervals. Among the M grayscale value subintervals, the subinterval including the maximum grayscale value displayable by the screen is [P₀, Pₘₐₓ], where P₀ is the threshold grayscale value, Pₘₐₓ is the maximum grayscale value displayable by the screen, 0<P₀≦Pₘₐₓ, M≧2 and M is an integer

In one exemplary implementation of step 308, the division of the grayscale value interval may include the following steps.

1. The terminal determines a grayscale value interval [0, Pₘₐₓ] displayable by the screen.

The grayscale value interval [0, Pₘₐₓ] displayable by the screen is an interval defined by a minimum grayscale value displayable by the screen and a maximum grayscale value displayed by the screen. For instance, when the screen is an 8 bit panel, the grayscale value interval displayable by the screen is [0, 255]. For another example, when the screen is a 10 bit panel, the grayscale value interval displayable by the screen is [0, 1023].

2. The terminal divides the grayscale value interval [0, Pₘₐₓ] into M grayscale value subintervals, where M≧2 and M is an integer.

The terminal may divide the grayscale value interval [0, Pₘₐₓ] in an equal or unequal manner. In the equal manner, the terminal divides the grayscale value interval [0, Pₘₐₓ] into M grayscale value subintervals with equal lengths. The present disclosure defines the length of a grayscale value interval or subinterval as the difference between the maximum grayscale value and the minimum grayscale value of the interval or subinterval. For example, the terminal may equally divide a grayscale value interval [0, 255] into 32 grayscale value subintervals. The 32 grayscale value subintervals are consecutively [0, 7], [8, 15], . . . , [8i, 8i+7], . . . , [240, 247], and [248, 255], where i is an integer.

In the unequal manner, the terminal divides the grayscale value interval into M grayscale value subintervals. The length of the (i+1)th grayscale value subinterval [P₍ᵢ₊₁₎ₘᵢₙ, P₍ᵢ₊₁₎ₘₐₓ] is greater than or equal to the length of the ith grayscale value subinterval [P₍ᵢ₎ₘᵢₙ, P₍ᵢ₎ₘₐₓ]. That is, (P₍ᵢ₊₁₎ₘₐₓ−P₍ᵢ₊₁₎ₘᵢₙ)≧(P₍ᵢ₎ₘₐₓ−P₍ᵢ₎ₘᵢₙ) where P₍ᵢ₊₁₎ₘᵢₙ=P₍ᵢ₎ₘₐₓ+1, 1≦i≦M−1, and i is an integer. This way, the distribution of the grayscale value subintervals in lower orders is relatively denser than the distribution of the grayscale value subintervals in higher orders. Therefore, the unequal manner takes into account the fact that the grayscale value subintervals in lower orders are more sensitive to the grayscale adjustment. For example, the terminal may unequally divide the grayscale value interval [0, 255] into 30 grayscale value subintervals, with the 30 grayscale value subintervals being consecutively [0, 5], [6, 11], . . . , [130, 138], . . . , [245, 255].

3. The terminal sets a corresponding duty ratio for each grayscale value subinterval, and saves the corresponding relationship between the grayscale value subintervals and the duty ratios.

To instruct the backlight driving IC to control the backlight intensity, the terminal may set the corresponding duty ratio for each grayscale value subinterval in advance. The duty ratios are positively correlated to the grayscale values and the backlight intensities respectively. Moreover, the duty ratio corresponding to the grayscale value subinterval [P₀, Pₘₐₓ] is set to be 100%. For instance, the terminal may divide grayscale value interval [0, 255] into 30 grayscale value subintervals in series. The terminal may set the duty ratio corresponding to the first grayscale value subinterval to 40%, and the duty ratio corresponding to the 30th grayscale value subinterval to 100%. As the serial number of the grayscale value subinterval increases, the respective duty ratio also increases.

As described above, P₀ is the threshold grayscale value and belongs to the grayscale value subinterval including the maximum displayable grayscale value, i.e., [P₀, Pₘₐₓ]. Accordingly, when the minimum value determined in step 304 belongs to the subinterval [P₀, Pₘₐₓ] the minimum value reaches or exceeds the threshold grayscale value. In contrast, when the minimum value does not belong to the subinterval [P₀, Pₘₐₓ], the minimum value does not reach the threshold grayscale value.

FIG. 3C is a schematic diagram illustrating a grayscale value distribution 33, according to an exemplary embodiment. Referring to FIG. 3C, the horizontal axis 34 indicates the serial numbers of the grayscale value subintervals. The grayscale values in each subinterval increase as the serial number increase. The vertical axis 35 indicates the number of the pixels. For example, the terminal may divide the grayscale value interval [0, 255] into 30 grayscale value subintervals. When the minimum value determined in step 304 is 255, the terminal may determine that the minimum value belongs to the 30th grayscale value subinterval, such as [245, 255]. Therefore, in the example illustrated by FIG. 3C, the minimum value exceeds the threshold grayscale value. FIG. 3D is a schematic diagram illustrating another grayscale value distribution 36, according to an exemplary embodiment. Referring to FIG. 3D, the terminal may divide the grayscale value interval [0, 255] into 30 grayscale value subintervals. When the minimum value is 187, the terminal may determine that the minimum value belongs to the 22nd grayscale value subinterval. For instance, the 22nd grayscale value subinterval may be [182, 190]. Therefore, in the example illustrated by FIG. 3D, the minimum value does not reach the threshold grayscale value.

In step 310, the terminal determines, according to a predefined corresponding relationship, a duty ratio corresponding to the grayscale value subinterval that includes the minimum value.

As described above, the predefined corresponding relationship is set and saved in step 308. For instance, the duty ratio corresponding to the 30th grayscale value subinterval [245, 255] may be 100%. For another instance, the duty ratio corresponding to the 22nd grayscale value subinterval [182, 190] may be 80%.

In step 312, the terminal sends a PWM signal with the determined duty ratio to a backlight driving IC. The PWM signal is configured to instruct the backlight driving IC to control the backlight intensity of the display block according to the determined duty ratio.

As described in step 308, the duty ratio is positively correlated to the backlight intensity. For example, a PWM signal with 100% duty ratio may be configured to instruct the backlight driving IC to control the backlight intensity of the display block to a maximum backlight intensity. For another example, a PWM signal with 80% duty ratio may be configured to instruct the backlight driving IC to control the backlight intensity of the display block to be 80% of the maximum backlight intensity.

Moreover, when the duty ratio of the PWM signal is 100%, the terminal controls the grayscale value of the image to be unchanged. When the duty ratio of the PWM signal is lower than 100%, the terminal increases the grayscale values of the image in a manner that the increase of the grayscale values is balanced with the decrease of the backlight intensity so as to keep the brightness of the image consistent before and after the performance of the method 300. This way, when the image has no pixel with high grayscale values, the terminal performs the CABC process on the image to reduce the power consumption by the backlight. In contrast, when the image has pixels with high grayscale values, such as white pixels, the terminal does not perform the CABC process on the image, thereby preserving the image contrast and display effect.

In addition, according to the method 300, when the predetermined number is set to 1 in step 304 and the image has one pixel with a high grayscale value, such as a white pixel, the terminal may output the PWM signal with 100% duty ratio to instruct the backlight driving IC to control the backlight intensity of the display block to be the maximum backlight intensity. This way, the loss of image contrast may be completely avoided.

In exemplary embodiments, after the execution of step 304, instead of comparing the minimum value with the threshold grayscale value (step 306), the terminal may directly proceed to step 308 to obtain the grayscale value subinterval that includes the minimum value and then decide whether to perform the CABC on the image according to the duty ratio corresponding to the obtained grayscale value subinterval.

The above description about the method 300 is for illustrative purpose only. The actual implementations of the method 300 may be based on various actual requirements. For example, the terminal may divide the grayscale value interval displayable by the screen into any number of subintervals using any method. For another example, the terminal may set the duty ratios corresponding to the respective grayscale value subintervals based on any actual requirement.

The above-disclosed method 300 applies the CABC on an image when the image has no pixels with high grayscale values (for example, no white pixels), but does not apply the CABC on the image when the image has one or more pixels with high grayscale values. Such a dynamic backlight control method not only reduces the power consumption by the backlight, but also keeps the image contrast and display effect consistent.

Moreover, by dividing the grayscale value interval displayable by the screen into multiple grayscale value subintervals, and setting a corresponding PWM signal duty ratio for each subinterval, the method 300 simplifies the data computation and processing, thereby improving the efficiency of the backlight control.

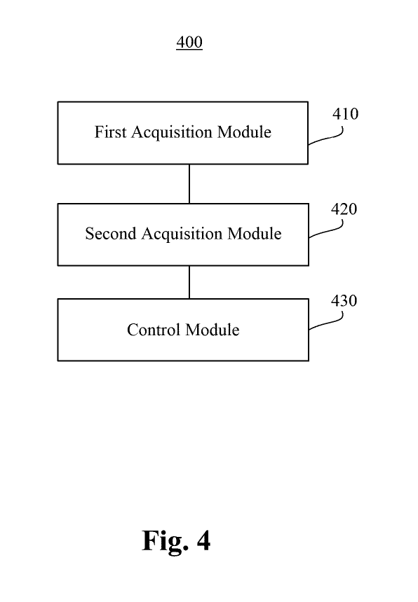

FIG. 4 is a block diagram of a backlight control device 400, according to an exemplary embodiment. For example, the device 400 may be part or whole of a terminal by means of hardware, or software, or a combination of hardware and software. Referring to FIG. 4, the device 400 may include a first acquisition module 410, a second acquisition module 420, and a control module 430.

The first acquisition module 410 is configured to acquire grayscale values of respective pixels in an image displayed in a display block. The screen of the terminal may include one or more display blocks. The first acquisition module 410 may acquire the grayscale values for each display block.

The second acquisition module 420 is configured to determine, according to the grayscale values acquired by the first acquisition module 410, the minimum value among a predetermined number of largest grayscale values.

The control module 430 is configured to, when the minimum value reaches or exceeds a threshold grayscale value, control the grayscale values of the pixels to be unchanged, and control a backlight intensity of the display block to be a maximum backlight intensity.

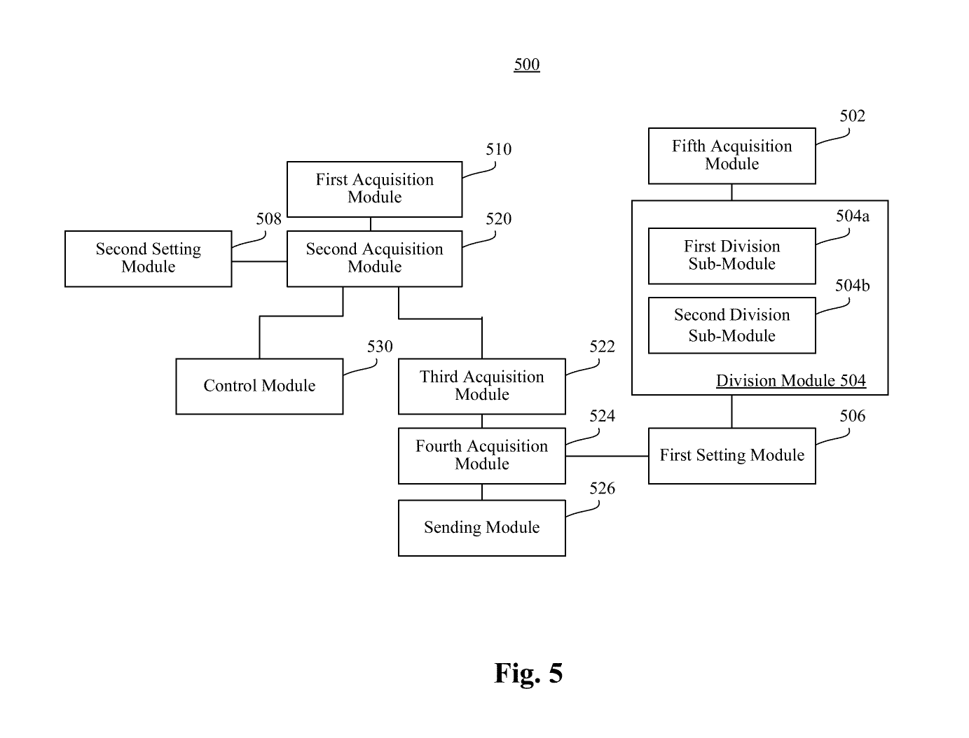

FIG. 5 is a block diagram of a backlight control device 500, according to an exemplary embodiment. For example, the device 500 may be part or whole of a terminal by means of hardware, or software, or a combination of hardware and software. Referring to FIG. 5, the device 500 may include a first acquisition module 510, a second acquisition module 520, and a control module 530, similar to the first acquisition module 410, the second acquisition module 420, and the control module 430 (FIG. 4).

In some exemplary embodiments, the control module 530 may further include a sending sub-module and a control sub-module (not shown in FIG. 5).

The sending sub-module is configured to send a PWM signal with 100% duty ratio to a backlight driving IC of the terminal. The PWM signal with 100% duty ratio is configured to instruct the backlight driving IC to control the backlight intensity of the display block to be the maximum backlight intensity.

The control sub-module is configured to control the grayscale values of the respective pixels to be unchanged.

In some exemplary embodiments, the device 500 may further include a third acquisition module 522, a fourth acquisition module 524, and a sending module 526.

The third acquisition module 522 is configured to, when the minimum value determined by the second acquisition module 520 does not reach the grayscale value threshold, determine a grayscale value subinterval that includes the minimum value.

The fourth acquisition module 524 is configured to determine, according to a predefined corresponding relationship between the grayscale value subintervals and the duty ratios, a duty ratio corresponding to the grayscale value subinterval that includes the minimum value. The duty ratio is positively correlated to the grayscale value and the backlight intensity. The grayscale value subinterval [P₀, Pₘₐₓ] corresponds to a duty ratio of 100%, where P₀ is the threshold grayscale value, Pₘₐₓ is the maximum grayscale value displayable by the screen, and 0<P₀<Pₘₐₓ.

The sending module 526 is configured to send the backlight driving IC a PWM signal with the duty ratio determined by the fourth acquisition module 524. The PWM signal is configured to instruct the backlight driving IC to control the backlight intensity of the display block according to the duty ratio.

In some exemplary embodiments, the device 500 may further include a fifth acquisition module 502, a division module 504, and a first setting module 506.

The fifth acquisition module 502 is configured to determine a grayscale value interval [0, Pₘₐₓ] displayable by the screen.

The division module 504 is configured to divide the grayscale value interval [0, Pₘₐₓ] into M grayscale value subintervals, where M≧2 and M is an integer.

The first setting module 506 is configured to set a corresponding duty ratio for each grayscale value subinterval, and save the corresponding relationship between the grayscale value subintervals and the duty ratios.

In some exemplary embodiments, the division module 504 may further include a first division sub-module 504a and/or a second division sub-module 504b.

The first division sub-module 504a is configured to divide the grayscale value interval [0, Pₘₐₓ] into M grayscale value subintervals in an equal manner. The resulted M subintervals have equal lengths.

The second division sub-module 504b is configured to divide the grayscale value interval [0, Pₘₐₓ] into M grayscale value subintervals in a unequal manner. In this manner, the length of the (i+1)th grayscale value subinterval [P₍ᵢ₊₁₎ₘᵢₙ, P₍ᵢ₊₁₎ₘₐₓ] is greater than or equal to the length of the ith grayscale value subinterval [P₍ᵢ₎ₘᵢₙ, P₍ᵢ₎ₘₐₓ], where P₍ᵢ₊₁₎ₘᵢₙ=P₍ᵢ₎ₘₐₓ+1, 1≦i≦M−1, and i is an integer.

In some exemplary embodiments, the device 500 may further include a second setting module 508.

The second setting module 508 is configured to set the predetermined number used by the second acquisition module 520 to 1, when no contrast loss is permitted during the application of the CABC on the image.

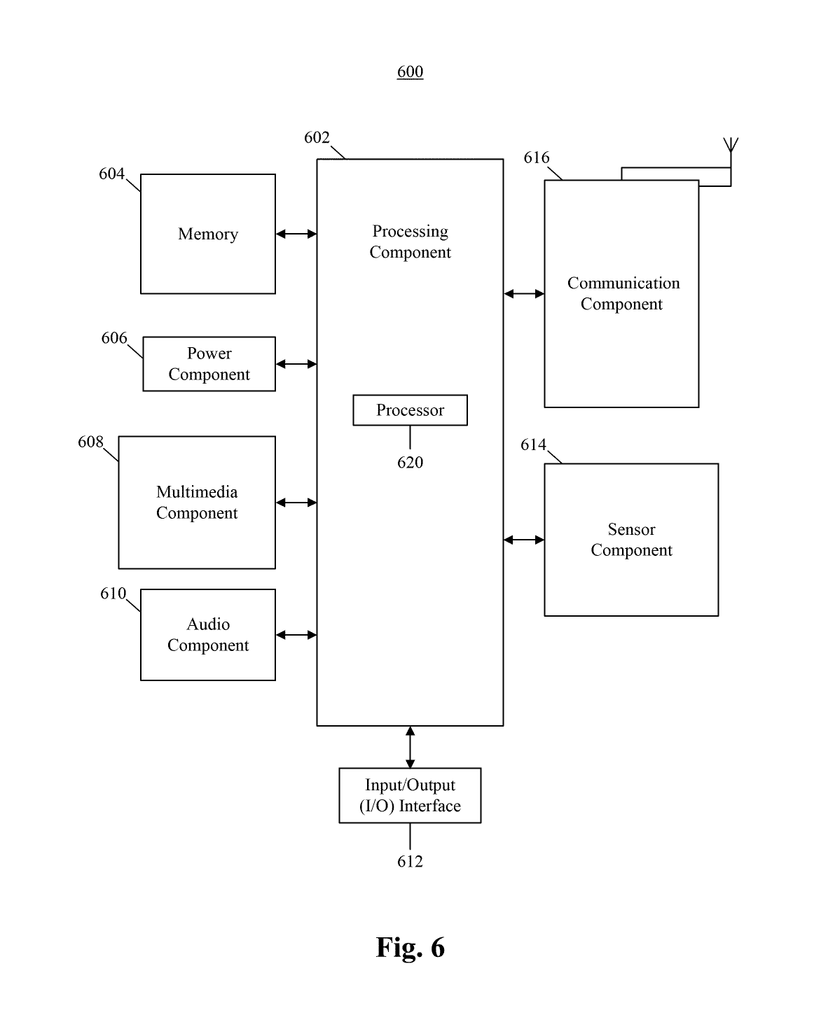

FIG. 6 is a block diagram of a device 600 for controlling backlight, according to an exemplary embodiment. For example, the device 600 may be a mobile phone, a computer, a digital broadcast terminal, a messaging device, a gaming console, a tablet, a medical device, exercise equipment, a personal digital assistant, and the like.

Referring to FIG. 6, the device 600 may include one or more of the following components: a processing component 602, a memory 604, a power component 606, a multimedia component 608, an audio component 610, an input/output (I/O) interface 612, a sensor component 614, and a communication component 616.

The processing component 602 typically controls overall operations of the device 600, such as the operations associated with display, telephone calls, data communications, camera operations, and recording operations. The processing component 602 may include one or more processors 620 to execute instructions to perform all or part of the steps in the above described methods. Moreover, the processing component 602 may include one or more modules which facilitate the interaction between the processing component 602 and other components. For instance, the processing component 602 may include a multimedia module to facilitate the interaction between the multimedia component 608 and the processing component 602.

The memory 604 is configured to store various types of data to support the operation of the device 600. Examples of such data include instructions for any applications or methods operated on the device 600, contact data, phonebook data, messages, pictures, video, etc. The memory 604 may be implemented using any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power component 606 provides power to various components of the device 600. The power component 606 may include a power management system, one or more power sources, and any other components associated with the generation, management, and distribution of power in the device 600.

The multimedia component 608 includes a screen providing an output interface between the device 600 and the user. In some embodiments, the screen may include a LCD and a touch panel (TP). If the screen includes the touch panel, the screen may be implemented as a touch screen to receive input signals from the user. The touch panel includes one or more touch sensors to sense touches, swipes, and gestures on the touch panel. The touch sensors may not only sense a boundary of a touch or swipe action, but also sense a period of time and a pressure associated with the touch or swipe action. In some embodiments, the multimedia component 608 includes a front camera and/or a rear camera. The front camera and the rear camera may receive external multimedia data while the device 600 is in an operation mode, such as a photographing mode or a video mode. Each of the front camera and the rear camera may be a fixed optical lens system or have focus and optical zoom capability.

The audio component 610 is configured to output and/or input audio signals. For example, the audio component 610 includes a microphone configured to receive an external audio signal when the device 600 is in an operation mode, such as a call mode, a recording mode, and a voice recognition mode. The received audio signal may be further stored in the memory 604 or transmitted via the communication component 616. In some embodiments, the audio component 610 further includes a speaker to output audio signals.

The I/O interface 612 provides an interface between the processing component 602 and peripheral interface modules, such as a keyboard, a click wheel, buttons, and the like. The buttons may include, but are not limited to, a home button, a volume button, a starting button, and a locking button.

The sensor component 614 includes one or more sensors to provide status assessments of various aspects of the device 600. For instance, the sensor component 614 may detect an open/closed status of the device 600, relative positioning of components, e.g., the display and the keypad, of the device 600, a change in position of the device 600 or a component of the device 600, a presence or absence of user contact with the device 600, an orientation or an acceleration/deceleration of the device 600, and a change in temperature of the device 600. The sensor component 614 may include a proximity sensor configured to detect the presence of nearby objects without any physical contact. The sensor component 614 may also include a light sensor, such as a CMOS or CCD image sensor, for use in imaging applications. In some embodiments, the sensor component 614 may also include an accelerometer sensor, a gyroscope sensor, a magnetic sensor, a pressure sensor, or a temperature sensor.

The communication component 616 is configured to facilitate communication, wired or wirelessly, between the device 600 and other devices. The device 600 can access a wireless network based on a communication standard, such as WiFi, 2G, 3G, 4G, or a combination thereof. In one exemplary embodiment, the communication component 616 receives a broadcast signal or broadcast associated information from an external broadcast management system via a broadcast channel. In one exemplary embodiment, the communication component 616 further includes a near field communication (NFC) module to facilitate short-range communications. For example, the NFC module may be implemented based on a radio frequency identification (RFID) technology, an infrared data association (IrDA) technology, an ultra-wideband (UWB) technology, a Bluetooth (BT) technology, and other technologies.

In exemplary embodiments, the device 600 may be implemented with one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, for performing the above described methods.

In exemplary embodiments, there is also provided a non-transitory computer-readable storage medium including instructions, such as included in the memory 604, executable by the processor 620 in the device 600, for performing the above-described methods. For example, the non-transitory computer-readable storage medium may be a read-only memory (ROM), a random access memory (RAM), a CD-ROM, a magnetic tape, a floppy disc, an optical data storage device, and the like.

One of ordinary skill in the art will understand that the above-described modules can each be implemented by hardware, or software, or a combination of hardware and software. One of ordinary skill in the art will also understand that multiple ones of the above-described modules may be combined as one module, and each of the above-described modules may be further divided into a plurality of sub-modules.

Other embodiments of the present disclosure will be apparent to those skilled in the art from consideration of the specification and practice of the present disclosure. This application is intended to cover any variations, uses, or adaptations of the present disclosure following the general principles thereof and including such departures from the present disclosure as come within known or customary practice in the art. It is intended that the specification and examples be considered as exemplary only, with a true scope and spirit of the invention being indicated by the following claims.

It will be appreciated that the present invention is not limited to the exact construction that has been described above and illustrated in the accompanying drawings, and that various modifications and changes can be made without departing from the scope thereof. It is intended that the scope of the invention only be limited by the appended claims.

What is claimed is:

1. A backlight control method, comprising:
acquiring, for a display block in a screen, grayscale values of respective pixels in an image displayed in the display block, the screen including one or more display blocks;
determining, according to the acquired grayscale values, a minimum value among a predetermined number of largest grayscale values; and
when the minimum value reaches or exceeds a threshold grayscale value, controlling the grayscale values of the respective pixels to be unchanged, and controlling a backlight intensity of the display block to be a maximum backlight intensity.

2. The method of claim 1, further comprising:
when the minimum value does not reach the threshold grayscale value, determining a grayscale value subinterval that includes the minimum value;
determining, according to a corresponding relationship between grayscale value subintervals and duty ratios, a first duty ratio corresponding to the grayscale value subinterval that includes the minimum value, wherein
the duty ratios are positively correlated to grayscale values in the grayscale value subintervals, and are positively correlated to backlight intensities, and
a grayscale value subinterval [P₀, Pₘₐₓ] has a corresponding duty ratio of 100%, P₀ being the threshold grayscale value, Pₘₐₓ being a maximum grayscale value displayable by the screen, and 0<P₀≦Pₘₐₓ; and
sending a pulse width modulation (PWM) signal with the first duty ratio to a backlight driving integrated circuit (IC), the PWM signal being configured to instruct the backlight driving IC to control the backlight intensity of the display block according to the first duty ratio.

3. The method of claim 2, further comprising:
determining a grayscale value interval [0, Pₘₐₓ] displayable by the screen;
dividing the grayscale value interval [0, Pₘₐₓ] into M grayscale value subintervals, wherein M≧2 and M is an integer; and
setting a corresponding duty ratio for each grayscale value subinterval, and saving the corresponding relationship between the grayscale value subintervals and the duty ratios.

4. The method of claim 3, wherein the dividing of the grayscale value interval [0, Pₘₐₓ] into the M grayscale value subintervals comprises:
dividing the grayscale value interval [0, Pₘₐₓ] into the M grayscale value subintervals in an equal manner, such that the M grayscale value subintervals have an equal length; or
dividing the grayscale value interval [0, Pₘₐₓ] into the M grayscale value subintervals in an unequal manner, such that a length of an (i+1)th grayscale value subinterval [P₍ᵢ₊₁₎ₘᵢₙ, P₍ᵢ₊₁₎ₘₐₓ] is greater than or equal to a length of an ith grayscale value subinterval [P₍ᵢ₎ₘᵢₙ, P₍ᵢ₎ₘₐₓ], wherein P₍ᵢ₊₁₎ₘᵢₙ=P₍ᵢ₎ₘₐₓ+1, 1≦i≦M−1, and i is an integer;
wherein the length of a grayscale value subinterval is a difference between a maximum grayscale value of the subinterval and a minimum grayscale value of the subinterval.

5. The method of claim 1, further comprising:
when no contrast loss is permitted during application of a Content Adaptive Brightness Control (CABC) on the image, setting the predetermined number to 1.

6. The method of claim 2, further comprising:
when no contrast loss is permitted during application of a Content Adaptive Brightness Control (CABC) on the image, setting the predetermined number to 1.

7. The method of claim 3, further comprising:
when no contrast loss is permitted during application of a Content Adaptive Brightness Control (CABC) on the image, setting the predetermined number to 1.

8. The method of claim 4, further comprising:
when no contrast loss is permitted during application of a Content Adaptive Brightness Control (CABC) on the image, setting the predetermined number to 1.

9. A backlight controlling device, comprising:
a processor; and
a memory for storing instructions executable by the processor;
wherein the processor is configured to:
acquire, for a display block of a screen, grayscale values of respective pixels in an image displayed in the display block, the screen including one or more display blocks;
determine, according to the acquired grayscale values, a minimum value among a predetermined number of largest grayscale values; and
when the minimum value reaches or exceeds a threshold grayscale value, control the grayscale values of the respective pixels to be unchanged, and control a backlight intensity of the display block to be a maximum backlight intensity.

10. The device of claim 9, wherein the processor is further configured to:
when the minimum value does not reach the threshold grayscale value, determine a grayscale value subinterval that includes the minimum value;
determine, according to a corresponding relationship between grayscale values subintervals and respective duty ratios, a first duty ratio corresponding to the grayscale value subinterval that includes the minimum value, wherein
the duty ratios are positively correlated to the grayscale values in the subintervals, and are positively correlated to backlight intensities, and
a grayscale value subinterval [P₀, Pₘₐₓ] has a corresponding duty ratio of 100%, P₀ being the threshold grayscale value, Pₘₐₓ being a maximum grayscale value displayable by the screen, and 0<P₀<Pₘₐₓ; and
send a pulse width modulation (PWM) signal with the first duty ratio to a backlight driving integrated circuit (IC), the PWM signal being configured to instruct the backlight driving IC to control the backlight intensity of the display block according to the first duty ratio.

11. The device of claim 10, wherein the processor is further configured to:
determine a grayscale value interval [0, Pₘₐₓ] displayable by the screen;
divide the grayscale value interval [0, Pₘₐₓ] into M grayscale value subintervals, wherein M≧2 and M is an integer; and
set a corresponding duty ratio for each grayscale value subinterval, and save the corresponding relationship between the grayscale value subintervals and the duty ratios.

12. The device of claim 11, wherein the processor is further configured to:
divide the grayscale value interval [0, Pₘₐₓ] into the M grayscale value subintervals in an equal manner, such that the M grayscale value subintervals have an equal length; or
divide the grayscale value interval [0, Pₘₐₓ] into the M grayscale value subintervals in an unequal manner, such that a length of an (i+1)th grayscale value subinterval [P₍ᵢ₊₁₎ₘᵢₙ, P₍ᵢ₊₁₎ₘₐₓ] is greater than or equal to a length of an ith grayscale value subinterval [P₍ᵢ₎ₘᵢₙ, P₍ᵢ₎ₘₐₓ], wherein P₍ᵢ₊₁₎ₘᵢₙ=P₍ᵢ₎ₘₐₓ+1, 1≦i≦M−1, and i is an integer;
wherein the length of a grayscale value subinterval is a difference between a maximum grayscale value of the subinterval and a minimum grayscale value of the subinterval.

13. The device of claim 9, wherein the processor is further configured to:
when no contrast loss is permitted during application of a Content Adaptive Brightness Control (CABC) on the image, set the predetermined number to 1.

14. The device of claim 10, wherein the processor is further configured to:
when no contrast loss is permitted during application of a Content Adaptive Brightness Control (CABC) on the image, set the predetermined number to 1.

15. The device of claim 11, wherein the processor is further configured to:
when no contrast loss is permitted during application of a Content Adaptive Brightness Control (CABC) on the image, set the predetermined number to 1.

16. The device of claim 12, wherein the processor is further configured to:
when no contrast loss is permitted during application of a Content Adaptive Brightness Control (CABC) on the image, set the predetermined number to 1.

17. A non-transitory computer-readable storage medium storing instructions that, when executed by a processor of a terminal, cause the terminal to perform a backlight control method, the method comprising:
acquiring, for a display block in a screen, grayscale values of respective pixels in an image displayed in the display block, the screen including one or more display blocks;
determining, according to the acquired grayscale values, a minimum value among a predetermined number of largest grayscale values; and
when the minimum value reaches or exceeds a threshold grayscale value, controlling the grayscale values of the respective pixels to be unchanged, and controlling a backlight intensity of the display block to be a maximum backlight intensity.
